(19) United States
(12) Patent Application Publication
(10) Pub. No.: US 2004/0033127 A1
(43) Pub. Date: Feb. 19, 2004

(54) Motor assisted mover

(76) Inventors: Bruce Roseman, Mount Kisco, NY (US); Wayne Goldman, Morrisville, VT (US)

Correspondence Address: GREENBLUM & BERNSTEIN, P.L.C., 1950 ROLAND CLARKE PLACE, RESTON, VA, 20191, US

(21) Appl. No.: 10/219,272

(22) Filed: Aug. 16, 2002

(51) Int. Cl. B66F 1/00

(52) U.S. Cl. 414/608

(57) ABSTRACT

A motor assisted mover is provide for lifting and moving a device having wheels contacting a floor surface. The mover includes a tiltable mainframe including a plurality of free spinning wheels and at least one drive wheel, the tiltable mainframe being tiltable to selectively lift one of at least one of said plurality of free spinning wheels and the at least one drive wheel out of contact with a floor surface. The mover also includes a lifting frame including a lever arm and lifting attachments for removably attaching to a first end of the device. The mainframe and lifting frame are pivotably connected along a common horizontal axis. The lifting frame is structured and arranged to lift at least a first end of the device. The lifting frame and the tiltable mainframe are arranged such that, when the lifting frame is positioned so that the at least one end is lifted, the tiltable mainframe is arranged such that the at least one drive wheel contacts the floor.

### CROSS REFERENCE TO RELATED APPLICATIONS

The present application is related to U.S. Pat. No. 09/873,333, filed on Jun. 5, 2001, entitled “Motor-Assist Gurney Unit and Method”, the disclosure of which is expressly incorporated by reference herein in its entirety.

### BACKGROUND OF THE INVENTION

1. Field of the Invention

The present invention is related to motor assisted or motorized movers, and more particularly, to a motor assisted mover for assisting personnel in moving devices on wheels such as gurneys, wheelchairs, rolling chairs, rolling tables, diagnostic equipment, tool boxes, storage racks, food carriers, laundry carriers, luggage carriers or any other piece of equipment on wheels.

2. Description of Background Information

In a hospital, industrial, manufacturing, office and most any other environments which have smooth or flat rolling surfaces for floors, devices are typically utilized having wheels, such as caster wheels, rubber wheels, or small inflated tires, on the bottom of the devices so that they may be transported easily with less human effort.

For example, in a hospital setting, many devices such as gurneys (i.e., thin beds placed on a wheeled frame), are utilized to move patients from one area of the hospital to another as rapidly as possible. This can prove to be an exhausting task to some hospital staff who are not strong. The process can be complicated by old gurneys having worn-out wheel bearings that do not roll easily and/or by obese patients and less than fit hospital staff.

In the same hospital setting, there are many other devices which have wheels attached to the bottom of their structure, such as wheelchairs, accessory tables, care carts and medical diagnostic equipment which are capable of being moved or pushed by personnel, yet, are still heavy or bulky and which can be challenging to move if the task is attempted by only one person who may not be strong.

Another example, in the industrial environment, numerous examples of equipment with wheels can be found, such as large tool boxes, storage racks, diagnostic equipment, tables, etc. Many times these devices are very heavy and/or can be loaded with heavy tools, materials, or even manufactured products which make the moving of such device challenging, especially when the device is being transported by only one person. Also, devices on wheels, such as luggage racks, on commonly used in airports, train stations, on ships and ferry boats.

Several devices have been designed that are used to assist humans in moving devices on wheels. For example, attempts have been made to provide a motorized mover for hospital gurneys, such as devices described in a series of U.S. Patents to FOSTER et al., including U.S. Pat. Nos. 5,337,845, 5,547,831 and 5,513,406. In general, the Foster patents disclose a complex system of devices utilized in a hospital environment, including a modular gurney and modular motorized transport. The modular design of the gurney utilizes a “Y” shaped footprint specific to the system disclosed. Because the FOSTER motorized transport is not compatible with other gurneys not utilizing the “Y” shaped footprint, the FOSTER system is not universal with respect to a variety of other hospital gurneys which are more commonly used. Furthermore, the FOSTER system is much more complex and expensive than most hospitals are willing to spend.

Other devices have been created that are attachable to non-motorized wheelchairs as a propulsion device. Such devices are described in U.S. Pat. Nos. 5,826,670 to NAN, U.S. Pat. No. 5,125,468 to COKER, U.S. Pat. No. 5,135,063 to KROPF and U.S. Pat. No. 2,978,053 to SCHMIDT. These devices, however, suffer from several shortcomings. For instance, these devices are designed with the intention to enable the wheelchair user to steer and drive the wheelchair himself/herself, as opposed to someone pushing the wheelchair. Such a device is not helpful for a patient that does not have the physical motor skills to drive the wheel chair, or who is in no position to be driving himself anywhere after surgery. Furthermore, these disclosed wheelchair attachment devices are generally difficult to attach and detach from a wheelchair, especially as wheelchairs come in different designs and sizes. As such, it would be impractical to use such a device with any other piece of equipment, such as a gurney or portable storage shelves.

A motorized mover for moving grocery carts is disclosed in U.S. Pat. No. 5,860,485 to EBBENGA. The grocery cart mover includes a drive mechanism and a mechanism for engaging the line of grocery carts. The engaging mechanism is configured and arranged so that upon activation of the drive mechanism, the engaging mechanism lifts the carts horizontally in a desired direction. The drive mechanism is pivotally connected to the cart engaging mechanism to facilitate steering of the cart engaging mechanism and the line of carts. A disadvantage of the EBBENGA mover is that its steering system does not allow the user to move the carts laterally away from a wall or object of which the carts have been positioned next. Thus, the EBBENGA mover has some limitations with respect to maneuverability.

Other motorized movers have been disclosed such as U.S. Pat. Nos. 4,289,212 to IMMEL and U.S. Pat. No. 3,417,833 to McRAE. Both devices teach a battery powered device for pushing disabled vehicles and having a frame designed to support a portion of the vehicle's weight. The downfall for these motorized movers is that they are both heavy duty designs for specifically pushing vehicles. Thus, the size and weight of the IMMEL and McRAE devices are not scaled for moving smaller devices such as gurneys, wheelchair, portable tables. etc., and therefore, they are more heavy duty than required. Another drawback to both designs is that they are only capable of pulling. Furthermore, the steering ability of both IMMEL and McRAE does not provide for lateral movement away from a wall or any other obstruction where the transported device may be positioned next.

Finally, a self-propelled steering device is disclosed in U.S. Pat. No. 4,210,217 to LACHOWICZ. This device is designed to move automobile trailers after they have been disconnected from the automobile. A drawback of this type of motorized mover is that it is only designed to be adapted to move trailers and does not have the proper attachment features for moving items such as gurneys, wheelchairs, portable racks, etc. Thus, the LACHOWICZ design does not have the flexibility to move a variety of devices.

It is desirable to have a motor assisted mover which overcomes the drawbacks of the aforementioned devices. What is needed is a motorized mover which is capable of moving a variety of equipment on wheels (i.e., a mover that is not dedicated to one piece of equipment), such as gurneys, wheelchairs, rolling tables, rolling chairs and storage racks, etc.

It is also desirable to provide a mover which allows the equipment to be moved laterally (sideways) away from a wall or any other obstruction. Such a lateral steering feature would provide and easier way for personnel to move wheeled devices in the crowded rooms or hallways.

### SUMMARY OF THE INVENTION

A motor assisted mover is provided for assisting personnel in moving devices on wheels such as gurneys, wheelchairs, rolling chairs, rolling tables, diagnostic equipment, tool boxes, storage racks or any other piece of equipment on wheels. The motor assisted mover is also capable of moving equipment laterally away from a wall or any other obstruction. The device has many unique features which are herein described below.

The motor assisted mover has a single central drive wheel with an integrated direct current motor driving the wheel through a gear or chain reduction system. The motor assisted mover is fitted with a pivoting drive wheel and three caster wheels which are free turning.

When the motor assisted mover is “unloaded” the drive wheel is raised from contact with the floor. This facilitates the movement manually without power assist. When the load is engaged and lifted by the mover, the drive wheel comes in contact with the floor, thereby facilitating moving the load by driving the drive wheel via the motor.

The motor assisted mover also features a unique coupling system where the moving device engages the load with an adjustable locking mechanism which allows the operator to lift one side of the load with a mechanical lever. The mechanism automatically locks in the raised position which occurs when the wheel(s) on at least one side of the load are raised approximately ½ inch or more off the floor. A portion of the weight of the load is transferred onto the drive wheel and caster wheels of the motor assisted mover.

The motor assisted mover is also capable of moving equipment laterally away from a wall or any other obstruction. The mover has a drive wheel mechanism that is mounted to a fork which can be turned from an “inline” position to a “lateral” position by use of a direct current linear actuator. The actuator turns the drive wheel ninety degrees when the operator wants to move an object laterally from side to side, instead of forward or backward. When the drive wheel is in this position, the operator can move a wheeled device positioned next to a wall sideways by reversing the direction of rotation of drive motor reversing by the polarity of the onboard power source.

A benefit of the lateral steering feature is that will help eliminate the repeated danger of bumping into walls. For example, when a patient on a gurney has an endotracheal tube in place, it is essential that the gurney is moved without sudden jolts or bumping against other objects positioned within a hospital environment. With the motor assisted mover's ability to not only move forward and backward, but also sideways, it is possible to maneuver a gurney or any other wheeled device in manners which allow one to avoid obstructions in a crowded hallway or room much easier.

The mover features an onboard power system, which includes, e.g. 24 volt batteries and a charging system with a self-retracting power cord for plugging into a standard 115 volt AC power outlet. The battery charger can automatically adjust the charging rate depending upon the state of change of the 24 volt DC battery.

Another feature of the motor assisted mover is an adjustable and replaceable lifting mechanism which adapts to various designs of existing equipment. The mechanism incorporates lifting hooks which engage an existing cross tube on the load or a cross tube which can easily be attached to an existing load. In addition, the lifting mechanism may include of a series of detents, pins, or other retaining devices which will provide a system for locking the load in position while lifting.

An advantage of the motor assisted mover is that it reduces overhead expenses. For instance, typically two employees are required to move any large load on a wheeled device. To prevent injuries, many hospitals, companies or institutions impose a mandatory minimum of two people to move a heavy load on a wheeled device to prevent injuries. Given the mechanical advantage and the ability of the motorized mover to be operated safely and effectively by only one person, expenses overhead expenses can be reduced.

Another benefit of the motor assisted mover is the possibility to reduce on the job injuries to employees who have the task of moving loads on wheeled devices. For instance, in many work environments, back injuries are the number one cause of missed work days. The mechanical advantage of the motor assisted mover provides a safer alternative to the “brute force” methods still used in many environments. Thus, the motor assisted mover provides a safe alternative for moving wheeled devices, which in turn, reduces overhead expenses.

According to an aspect of the present invention, a motor assisted mover is provided for lifting and moving a device having wheels contacting a floor surface. The motor assisted mover includes a tiltable mainframe having a plurality of free spinning wheels and at least one drive wheel. The tiltable mainframe is tiltable to selectively lift one of at least one of the plurality of free spinning wheels and the at least one drive wheel out of contact with a floor surface. The mover further includes a lifting frame having a lever arm and lifting attachments for removably attaching to a first end of the device. The mainframe and lifting frame are pivotably connected along a common horizontal axis. The lifting frame is structured and arranged to lift at least a first end of the device, wherein the lifting frame and tiltable mainframe are arranged such that, when the lifting frame is positioned so that the at least one end is lifted, the tiltable mainframe is arranged such that the at least one drive wheel contacts the floor.

According to another aspect of the present invention, the mover has an integrated front wheel and motor drive assembly which includes the drive wheel and which is structured and arranged to pivot to a rotational axis of the drive wheel. Furthermore, the integrated front wheel and motor drive assembly rotates about a steering bearing and journal assembly. According to a further aspect of the present invention, the mover has an electric linear actuator which selectively moves the drive wheel from an “in-line” position to a “lateral” position.

In yet still another aspect of the present invention, the mover has positioning indicator switches located proximate to the lifting attachments which, when contacted by the device. According to another aspect of the present invention, the motor assisted mover according, further includes positioning indicator switches located proximate to the lifting attachments which, when contacted by the wheeled device, turn a position indicator light on.

Another aspect of the invention includes a locking mechanism which locks the lifting frame relative to the tiltable mainframe such that the at least one end of the device is in a lifted position. Furthermore, the mover lifts the wheeled device about ½ inch off the floor.

According to still another aspect of the present invention, the mover includes a power supply with on board batteries and a charging system coupled to the power supply. The motor assisted mover charging system may include a self-retracted cord for plugging into a standard 115 volt AC power outlet. The battery charger is capable of adjusting a charging rate depending upon a state of change of said on-board batteries.

Moreover, according to another aspect of the present invention the lift attachments may be one of lifting hooks, a series of detents, a series of pins, and retaining devices which provide a secure engagement connection between the mover and the at least one end of device.

According to another aspect of the present invention, a method is provided for utilizing a motor assisted mover for lifting and moving a device having wheels contacting a floor surface. The method utilizes a motor assisted mover comprising a mainframe having a plurality of free spinning wheels and at least one drive wheel, and a lifting frames, including a lever arm and lifting attachments. The method includes lifting a load by pivoting said lifting frame relative to said mainframe, wherein as the load is lifted, at least one of said plurality of freely rotating wheels is lifted from the floor and said at least one drive wheel is moved into contact with the floor.

According to another aspect of the present invention, the method further includes driving the drive wheel with a motor, whereby the wheeled device is moved. According to still yet another aspect of the present invention, the method includes pivoting the at least one drive wheel. Another aspect of the invention includes pivoting the at least one drive wheel is from an “inline” position to a “lateral” position. Moreover, the method includes driving the pivoted at least one drive wheel, whereby the device is moved laterally.

Other exemplary embodiments and advantages of the present invention may be ascertained by reviewing the present disclosure and the accompanying drawing.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 is an overall perspective of the motor assisted mover;

FIG. 2 is an isometric perspective of an embodiment of a mainframe of the motor assisted mover according to an aspect of the present invention;

FIG. 3 is an isometric perspective of an embodiment of a pivoting frame of the motor assisted mover according to an aspect of the present invention;

FIG. 4 is a side view of the forward frame portion with the drive wheel in an “in line” position and engaged to the ground;

FIG. 5 is a top view of the forward frame portion with the drive wheel in an “in line” position and engaged to the ground;

FIG. 6 is a top view of the forward frame portion with the drive wheel in a “lateral” position;

FIG. 7 shows the motor assisted mover next to a wheeled device just before it is engaged to the wheeled device;

FIG. 8 shows the motor assisted mover engaged to the gurney, but not lifted;

FIG. 9 shows the motor assisted mover with the drive wheel on the ground in operating position.

### DETAILED DESCRIPTION OF THE PRESENT INVENTION

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

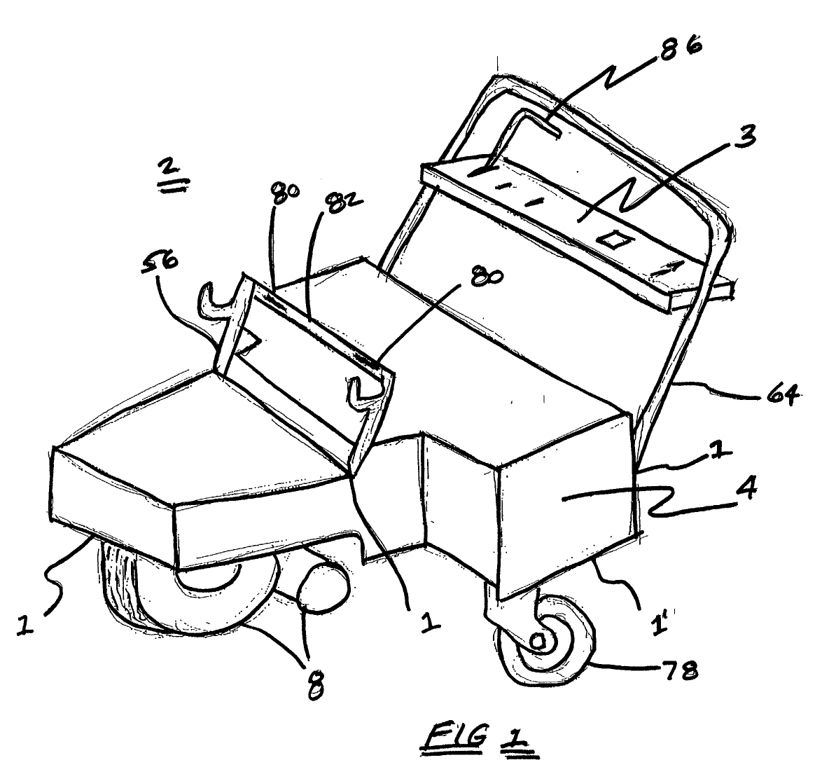

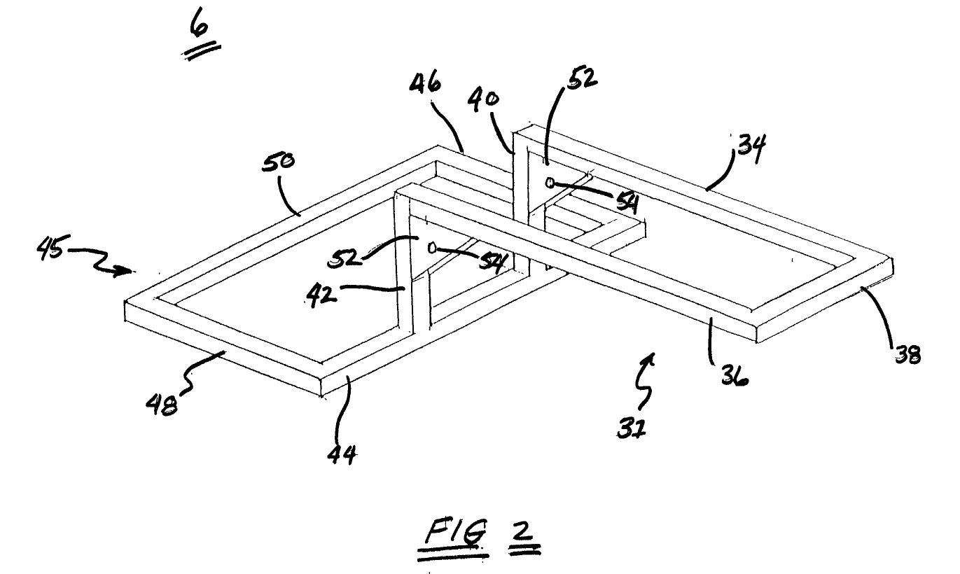

FIG. 1 depicts an embodiment of the motor assisted mover 2. A body cover 4 encloses a substantial portion of the main structures and components of the mover 2, except for operator control hoop 64, control panel 3, integrated front wheel and motor drive assembly 8, for lifting frame portion 56, and three caster wheels (two not illustrated in FIG. 1) mounted to the mainframe 6 (see FIG. 2) of the mover 2 in a triangular pattern. The control panel 3 provides mounting structure and support for instrumentation lights, switches, and controls. The body cover 4 has a body opening 1 for integrated front wheel and motor drive assembly 8, lifting frame portion 56 and operator control hoop 64.

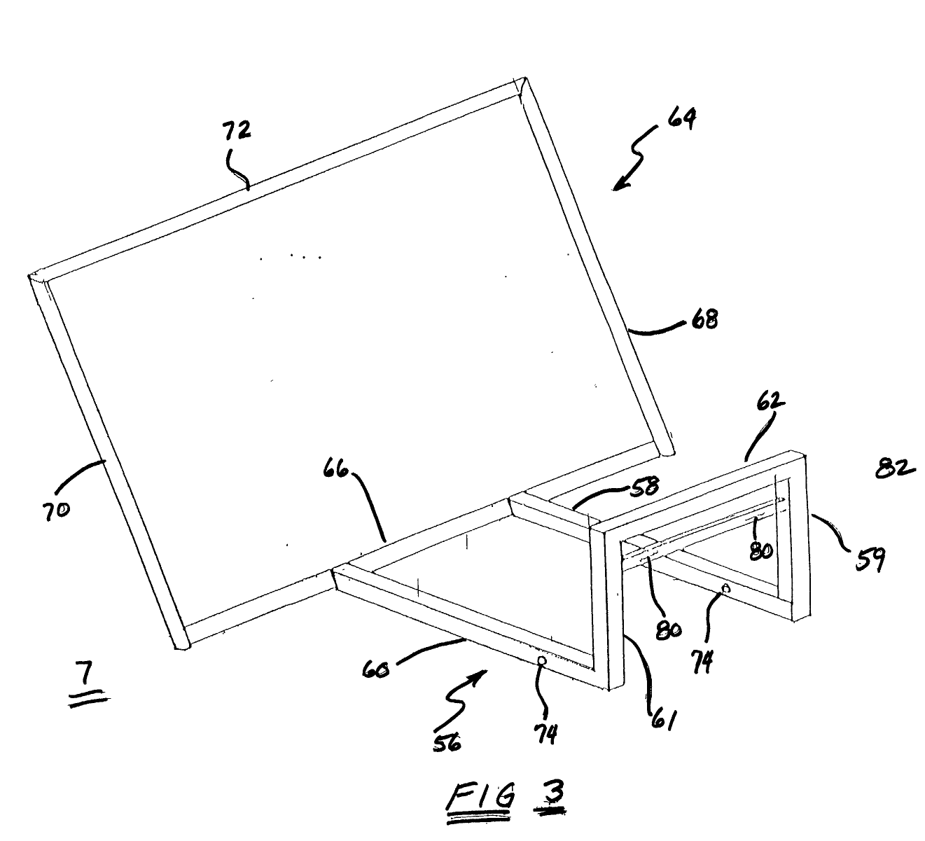

FIGS. 2-9 depict an embodiment of the motor assisted mover 2 with the body cover 4 removed. The motor assisted mover 2 has a chassis 23 which includes two subcomponents which are connected along a central pivoting axis: mainframe 6 (see FIG. 2) and pivoting frame 7 (see FIG. 3). The chassis 23 may be constructed from a variety of tubing materials such as steel, aluminum or any other high strength high light weight alloy known in the art suitable for chassis fabrication. The main frame 6 and pivoting frame 7 will be described in much greater detail later in the specification. Connected to a forward portion 31 of mainframe 6 is the integrated front wheel and motor drive assembly 8, which includes drive wheel 9, steering frame 20 and electric motor 18. Corrected to the bottom of the rear portion 45 of mainframe 9 in a triangular pattern are three free turning caster wheels 78. The rear portion 45 of mainframe 9 is also utilized to support battery floorboards 15, onboard batteries 17, and a charging system. By way of example, the charging system can include a self-retractable electric cord 19 which plugs into a standard 115 volt AC power outlet for recharging the batteries 17. In one embodiment, the battery charger can automatically adjust the charging rate depending upon the state of change of onboard batteries 17. By another embodiment, the mover 2 utilizes a 24 volt DC battery, which may be two 12 volt batteries connected in series.

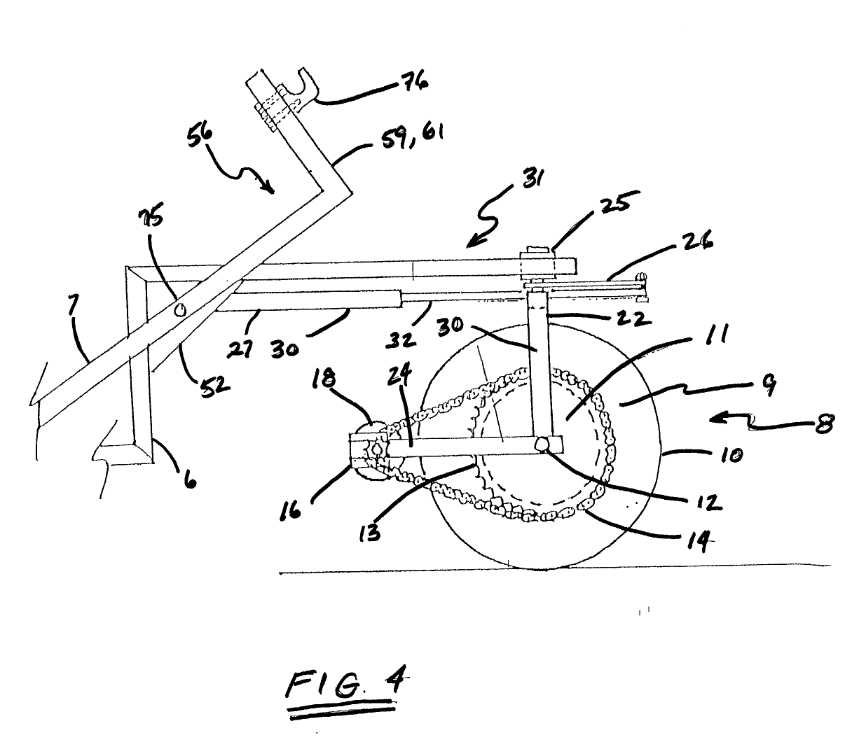

FIG. 2 illustrates an embodiment of mainframe 6 of the motor assisted mover 2. Mainframe 6 is composed of a forward frame portion 31 and a rear frame portion 45. The forward frame portion 31 comprises a left and right forward fork (lever) arm 34, 36 connected by a forward crossmember 38 which provides a mounting structure for the integrated front wheel and motor drive assembly 8, which is illustrated in greater detail in FIGS. 4-6. The rearframe portion 45 is a rectangular-shaped structure comprising a rear crossframe 50 and center crossframe 44 e.g., connected by a left and right rear frame members 46, 48. The forward frame portion 31 and rear frame portion 45 are interconnected by a left and right strut 40, 42, which connect to center crossframe 44, in a vertical and normal orientation. The upper ends of the left and right struts 40, 42 are connected to ends of the left and right forward fork arms 34, 36, such that the planes defined by the forward and rear frame portions 31, 45 are oriented in a parallel manner, e.g., at about 90 degrees as illustrated in the exemplary embodiment. At the connection point, strengthening gussets 52, are utilized not only to strengthen the aforementioned connection, but also to provide pivot receiving holes 54 for receiving bolts that pivotably couple the mainframe to the pivoting frame 7 (shown in FIG. 4 and FIGS. 7-9).

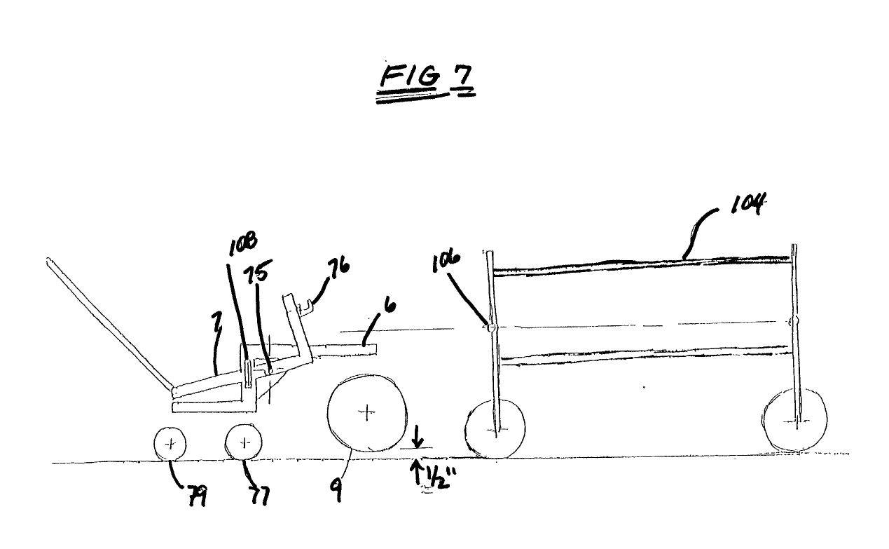

FIG. 3 depicts the pivoting frame 7 of the motor assisted mover 2. The pivoting frame 7 is composed of a lifting frame portion 56 and an operator lift element, such as for example, operator control hoop 64. The lifting frame portion 56 comprises left and right lifting arms 58, 60 connected to left and right lifting struts 59, 61, which are both connected by an upper transverse connecting member 62. The lifting frame portion 56 provides a mounting structure for the lifting hooks 76, e.g, on upper tranverse member 62 or lifting struts 59, 61. The lifting hooks 76 are arranged to attach to and lift at least one end a wheeled device such as a gurney or wheelchair. The operator control loop portion 64 is a rectangular-shaped frame comprising a main transverse connecting member 66 and hoop handle 72 connected by a left and right handle connecting members 68, 70. However, it is noted that other designs, including a simple lever can be utilized for the operator lift element The lifting frame portion 56 and operator control hoop portion 64 are rigidly connected to form the entire pivoting frame. In particular, the left and right lifting forks 58, 60 of the lifting frame 56 are rigidly connected to the main transverse connecting member 66. It should be noted that the operator control hoop 64 is connected to the left and right lifting forks 58, 60 in a manner which results in an obtuse angle, which is more clearly illustrated in FIGS. 7-9. Pivot holes 74 are provided for pivotably fastening the pivoting frame 7 to main frame 6. A mounting bracket 82 is interconnected between lifting struts 59, 61, which is used to mount microswitch positioning sensors 80, as shown in FIG. 1 and FIG. 4. The purpose of positioning switch sensors 80 will be described later in the specification.

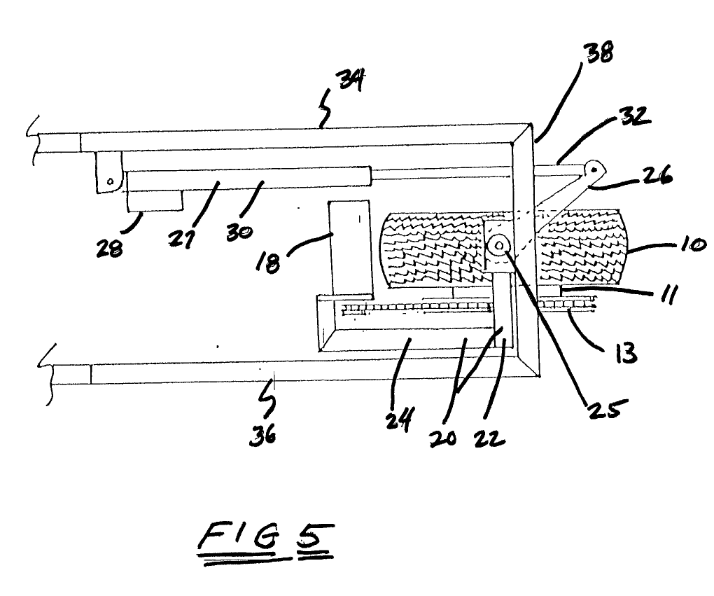

FIGS. 4-6 illustrate features of the steering system of the motor assisted mover 2. FIG. 5 is a side view of the forward frame portion 31 with the drive wheel 9, in an “in line” position (i.e., aligned straight forward) and engaged to the ground. In general, the steering system comprises integrated front wheel and motor drive assembly 8 having steering frame 20, electric motor 18, steering bearing and journal assembly 25, and electric linear actuator 27. The drive wheel 9 is composed of drive tire 10, which may be inflatable so as to provide sufficient traction while also providing a cushion which acts as a shock absorbing suspension, and hub 11. The tire 10 and hub 11 are mounted to the steering frame 20 via axle 12 attached the steering frame 20. Drive wheel 9 is mechanically driven by motor 18 utilizing a gear driven, belt driven, or chain reduction system. The embodiment featured in FIGS. 4-6, utilizes a sprocket 13 connected to hub 11. The sprocket 13 is configured to receive a chain drive 14 which engages a drive sprocket 16 which is connected the drive shaft of electric motor 18.

The steering frame 20 is utilized as rigid member which provides support for the drive wheel 9 and motor 18. The steering frame 20 may be constructed of the same materials that the chassis 23 is constructed. The steering frame 20 includes half yoke member 22 which attaches to the steering bearing and journal assembly 25. A horizontal motor support member 24 connects to the half yoke member 22 at about a 90 degree angle. The axle 12 is located where the half yoke 22 and the horizontal support member 24 are connected. Thus, the axis of the drive wheel axle 12 and the axis of the steering bearing and journal 25 directly intersect at the center of the wheel. Lifting frame portion 56: of pivoting frame 7 is rotatably connected to forward frame portion 31 of mainframe 6 about pivot axis 75.

Removably attached to lifting forks 59, 61 are lifting hooks 76, which engage an existing cross tube on the wheeled device or a cross tube which can easily be attached to a wheeled device. It should be noted that removable lifting hooks 76 may conform to a variety of shapes and sizes adaptable to a variety of structural components commonly found on wheeled devices. The lifting hooks 76 are adjustable and replaceable to adapt to various designs of existing equipment. In the alternative, a lifting system/mechanism may be substituted for the lifting hooks 76.

The lifting system/mechanism may include a series of detents, pins, or other retaining devices which will provide for locking the load in position while lifting. For instance, an alternative embodiment may include a spring loaded detent 112 which locks wheeled device 104 crossmember 106 into lifting hooks 76. When the wheeled device 104 is to be lowered, a solenoid 118 lifts the spring loaded detent 112 by either operator control or automatically to allow mover 2 to be disengaged from the wheeled device 104.

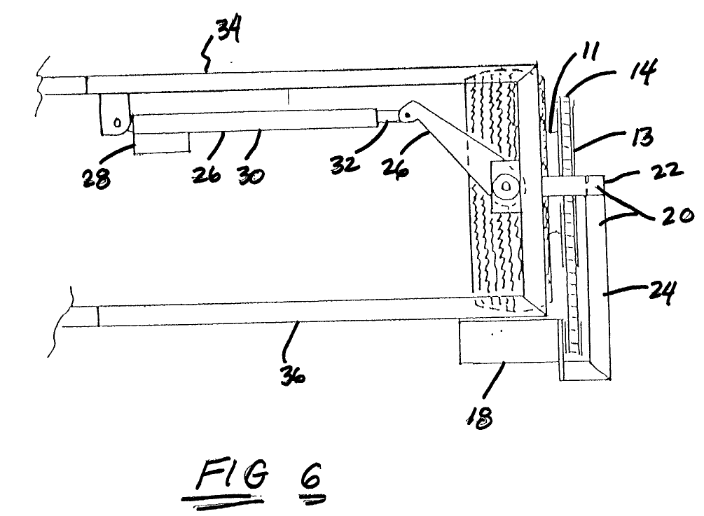

FIG. 5 is a top view of the forward frame portion with the drive wheel 9 in an “in line” position as also shown in FIG. 4. Electric linear actuator 27 is utilized to position drive wheel 9 from an “inline” position to a “lateral” position as shown in FIG. 6. Electric actuator 27 includes actuator motor 28, actuator receiving body 30 and actuator driving arm 32. Actuator driving arm 32 is rotatably attached to steering connecting bracket 26 which acts as the steering linkage between electric actuator 27 and steering bearing and journal assembly 25. When the operator of the mover 2 desires to move a wheeled device laterally and immediately away from a wall or obstruction, actuator 27 may be actuated by drive wheel position switch 96. Position switch 96 may be a two-position “rocker” switch having a “lateral position” and an “in-line position” In this case, the actuator driving arm 32 may turn drive wheel 9 about ninety degrees. When the drive wheel 9 is in this position, the operator can move from laterally away from the wall or obstruction by reversing the direction of rotation of drive motor 18, which reverses the polarity of the available 24 volt DC power source.

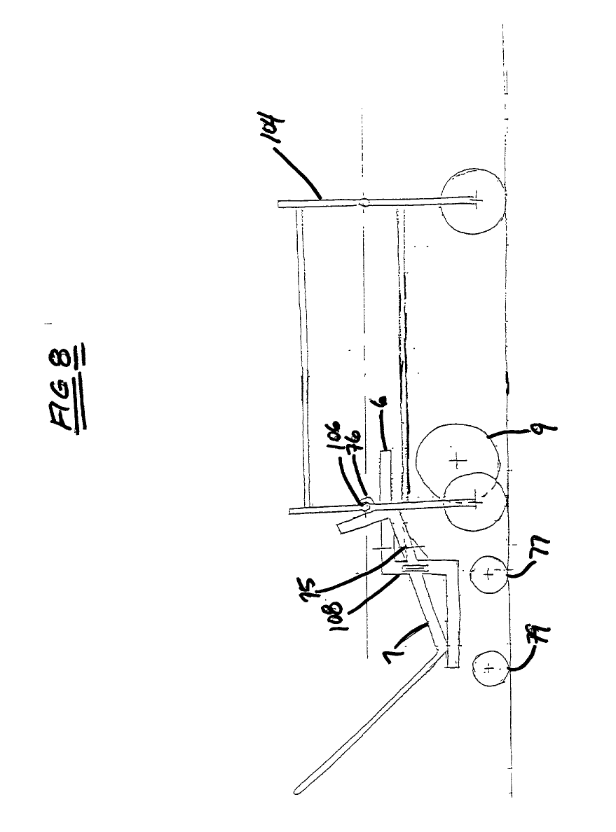

FIGS. 7-9 are provided to illustrate how the motor assisted mover lifts a device having wheels. FIG. 8 illustrates the motor assisted mover 2 in a disengaged state next to a wheeled device 104. Such devices typically have a crossmember 106 which is the portion of the wheeled device which the lifting hooks 76 of the mover will engage. Note that drive wheel 9 of the mover 2 is normally suspended about ½ inch above the ground when mover 2 is not engaged or loaded. Thus, when the mover 2 is “unloaded” the drive wheel 9 is raised from contact with the floor. This allows the mover 2 to be moved manually without the need to overcome the drag of the unenergized gear motor assembly, which facilitates the movement of the mover by the operator manually without power assist. Also note that rear caster wheel 79 and forward caster wheels 77 are supporting the entire weight of mover 2 and are in full contact with the floor surface.

FIG. 8 illustrates the mover 2 engaged to the wheeled device but still unloaded. Since the mover is unloaded, the drive wheel is still raised above the floor surface about ½ inch. When the mover lifting hooks 76 come in contact with the wheeled device crossmember 106, microswitches 80 are actuated and an indicator light on the control panel 3 is illuminated. Thus, this feature provides the operator of the mover 2 with feedback as to whether there is full engagement with the lifting hooks 76 and crossmember 106.

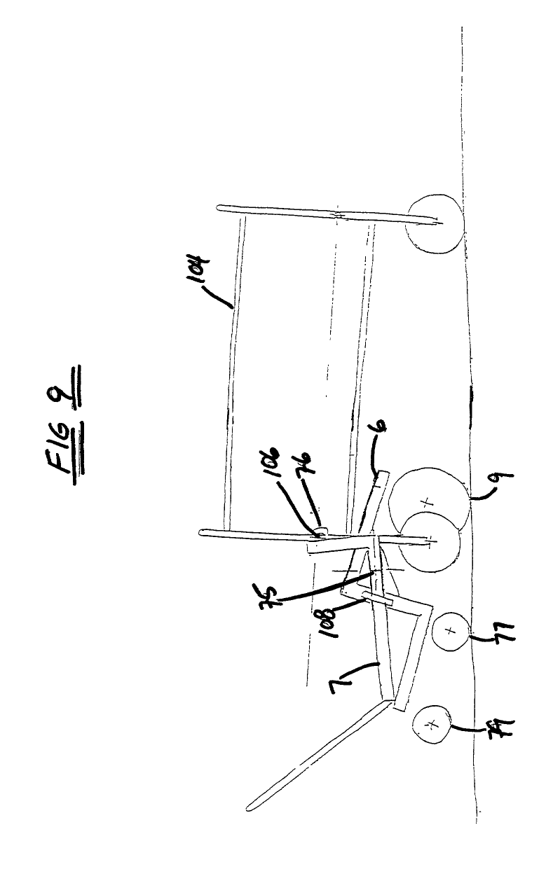

FIG. 9 illustrates the mover in an engaged and loaded state such that the wheeled device is lifted off the ground. As a result, the drive wheel 9 is forced downward such that it is in full contact with the floor surface. At this point, the drive wheel is under load from the wheeled device. The mover 2 is now fully engaged with the wheeled device 104, the wheeled device is lifted above the ground, and now the operator of the moving device may operate the mover 2 using the controls to move the wheeled device 104.

The mover 2 also features a coupling system where the moving device engages the load with an adjustable locking mechanism 108, which is spring loaded. The mechanism automatically locks in the raised position which occurs when the wheels from device 104 on one side of the load are raised approximately ½ inch of the floor. The locking mechanism 108 is released when the operator actuates the locking mechanism release switch 110 ( e.g., momementary contact switch) on control panel 3. At that time, the wheeled device can be released from mover 2. In this case, the operator puts pressure on the control hoop to remove the pressure on the locking mechanism 108 and to allow the wheeled device 104 to be lowered gently to the floor.

The control panel 3 for the mover 2 provides for a mounting structure for various controls, indicator lights and switches. A “dead man” control 86 is provided as a safety feature. When the user is operating mover 2, he/she should lift the “dead man” control to initiate movement (i.e., to energize the electric motor 18 to drive the drive wheel 9). When the “deadman” control is released by the operator, the mover immediately stops. The control panel also contains a power on/off switch 88, power indicator light 90, lift position indicator light 92, lift release switch 94, drive motor position switch 98, forward/reverse switch 100, battery charger indicator 102, and locking mechanism release switch 110.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF PARTS AND REFERENCE NUMBERS

1. body opening

2. motor assisted mover

3. control panel

4. body cover

5. dead man control

6. mainframe

7. pivoting frame

8. integrated front wheel and motor drive assembly

9. drive wheel

10. drive tire

11. hub

12. axle

13. sprocket orgear

14. chain

15. battery floor board

16. drive sprocket

17. battery

18. electric motor

19. self-retractable electric cord

20. steering frame

22. half yoke member

23. chassis

24. horizontal motor support member

25. steering bearing and journal assembly

26. steering connecting bracket

27. electric linear actuator

28. actuator motor

30. actuator receiving body

31. forward frame portion

32. actuator driving arm

34. left forward fork arm

36. right forward fork arm

38. forward crossmember

40. left vertical strut

42. right vertical strut

44. center crossframe

45. rear frame portion

46. left rear frame member

48. right rear frame member

50. rear crossframe

52. strengthening gussets

54. pivot receiving holes

56. lifting frame portion

58. left lifting fork

59. left lifting strut

60. right lifting fork

61. right lifting strut

62. upper transverse connection member

64. operator control hoop

66. main transverse connecting member

68. left handle connector member

70. right handle connector member

72. hoop handle

74. pivot holes

75. pivot axis

76. removable lifting hooks

77. forward caster wheel

78. caster wheel

79. rear caster wheel

80. microswitch positioning sensors

82. microswitch mounting bracket

84. control panel

86. “dead man” control

88. power on/off switch

90. power indicator light

92. lift position indicator light

94. lift release switch

96. drive wheel position switch

98. drive motor position switch

100. forward/reverse switch

102. battery charger indicator

104. wheeled device

106. wheeled device crossmember

108. locking mechanism

110. locking mechanism release switch

112. spring loaded detent

114. pins

116. retaining device

118. solenoid

What is claimed:

1. A motor assisted mover for lifting and moving a device having wheels contacting a floor surface, said device comprising:
a tiltable mainframe comprising a plurality of free spinning wheels and at least one drive wheel, said tiltable mainframe being tiltable to selectively lift one of at least one of said plurality of free spinning wheels and said at least one drive wheel out of contact with a floor surface;
a lifting frame comprising a lever arm and lifting attachments for removably attaching to a first end of the device;
said mainframe and said lifting frame being pivotably connected along a common horizontal axis;
said lifting frame being structured and arranged to lift at least a first end of the device;
said lifting frame and said tiltable mainframe being arranged such that, when the lifting frame is positioned so that the at least one end is lifted, said tiltable mainframe is arranged such that said at least one drive wheel contacts the floor.

2. The motor assisted mover according to claim 1, further comprising an integrated front wheel and motor drive assembly which includes the drive wheel and which is structured and arranged to pivot to a rotational axis of said drive wheel.

3. The motor assisted mover according to claim 2, wherein said integrated front wheel and motor drive assembly rotates about a steering bearing and journal assembly.

4. The motor assisted mover according to claim 2, further comprising a electric linear actuator which selectively moves the drive wheel from an “in-line” position to a “lateral” position.

5. The motor assisted mover according to claim 2, further comprising positioning indicator switches located proximate to said lifting attachments which, when contacted by the device, turn a position indicator light on.

6. The motor assisted mover according to claim 1, further comprising a locking mechanism which locks the lifting frame relative to said tiltable mainframe such that the at least one end of the device is in a lifted position.

7. The motor assisted mover according to claim 6, wherein the device is lifted about ½ inch off the floor.

8. The motor assisted mover according to claim 1, further comprising a power supply comprising on board batteries.

9. The motor assisted mover according to claim 8, further comprising a charging system coupled to said power supply.

10. The motor assisted mover according to claim 9, said charging system comprising a self-retracted cord for plugging into a standard 115 volt AC power outlet.

11. The motor assisted mover according to claim 10, wherein said battery charger adjusts a charging rate depending upon a state of change of said on-board batteries.

12. The motor assisted mover according to claim 1, said lift attachments being one of lifting hooks, a series of detents, a series of pins, and retaining devices which provide a secure engagement connection between said mover and the at least one end of device.

13. A method utilizing a motor assisted mover for lifting and moving a device having wheels contacting a floor surface, said motor assisted mover comprising a mainframe having a plurality of free spinning wheels and at least one drive wheel, and a lifting frames, including a lever arm and lifting attachments, said method comprising:
lifting a load by pivoting said lifting frame relative to said mainframe, wherein as the load is lifted, at least one of said plurality of freely rotating wheels is lifted from the floor and said at least one drive wheel is moved into contact with the floor.

14. The method according to claim 13, further comprising driving the drive wheel with a motor, whereby the device is moved.

15. The method according to claim 13, further comprising pivoting the at least one drive wheel.

16. The method according to claim 15, wherein the at least one drive wheel is pivoting from an “inline” position to a “lateral” position.

17. The method according to claim 16, further comprising driving the pivoted at least one drive wheel, whereby the device is moved laterally.
